(19) United States
(12) Patent Application Publication
(10) Pub. No.: US 2004/0117677 A1
(43) Pub. Date: Jun. 17, 2004

(54) Throttle of an integrated device

(76) Inventors: Sanjeev Jahagirdar, Fair Oaks, CA (US); Varghese George, Folsom, CA (US); Subramaniam Maiyuran, Goldriver, CA (US); Belliappa Kuttanna, Austin, TX (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/318,510

(22) Filed: Dec. 13, 2002

(51) Int. Cl. G06F 1/32

(52) U.S. Cl. 713/320

(57) ABSTRACT

Embodiments of system, method, and apparatus for a multi-level throttle of an integrated device are described.

### BACKGROUND

1. Field

This disclosure generally relates to power reduction with a throttle.

2. Background Information

The demand for more powerful computers and communication products has resulted in faster processors that often have higher die temperatures and consume increasing amounts of power. However, design engineers struggle with reducing power consumption and die temperature.

One typical solution is a full chip throttle that disables operation for the entire system or integrated device. However, a full chip throttle may have a detrimental impact on the processor's performance because the processor may intermittently halt execution of all instructions.

### BRIEF DESCRIPTION OF THE DRAWINGS

Subject matter is particularly pointed out and distinctly claimed in the concluding portion of the specification. The claimed subject matter, however, both as to organization and method of operation, together with objects, features, and advantages thereof, may best be understood by reference to the following detailed description when read with the accompanying drawings in which:

FIG. 1 is a schematic diagram illustrating an embodiment of a throttle logic apparatus in accordance with the claimed subject matter.

FIG. 2 is a flowchart illustrating an embodiment of a method in accordance with the claimed subject matter.

FIG. 3 is a block diagram illustrating a system that may employ the embodiment of either FIG. 1 or FIG. 2, or both.

### DETAILED DESCRIPTION

In the following detailed description, numerous specific details are set forth in order to provide a thorough understanding of the claimed subject matter. However, it will be understood by those skilled in the art that the claimed subject matter may be practiced without these specific details. In other instances, well-known methods, procedures, components and circuits have not been described in detail so as not to obscure the claimed subject matter.

An area of current technological development relates to achieving longer battery life for communication products and computer or computing systems by reducing power consumption. Typically, as the processor operates at a higher temperature, the performance of the transistors for the processor may degrade and become slower. Presently, a full chip throttle is utilized to reduce power consumption and die temperature. However, as previously discussed, a full chip throttle has a detrimental impact on performance of an integrated device, such as a processor, because the processor may intermittently halt execution of all instructions and result in the processor grinding to a halt. Thus, a full chip throttle is analogous to “slamming on the car brakes” to cause the car (processor) to grind to a halt when trying to reduce power consumption.

In contrast, an apparatus, system, and/or method that facilitate a multi-level throttle may be desirable, as described in the following detailed description. In one embodiment, a multi-level throttle may utilize a plurality of temperature set points and counters for establishing a plurality of throttle triggers. A throttle trigger may selectively throttle one or more logic partitions of the integrated device. Therefore, this embodiment of a multi-level throttle may offer more granularity for reducing power consumption than a full chip throttle by allowing flexibility to adjust the magnitude of the throttle based at least in part on temperature set-points for the logic partitions of the integrated device. In this context, then, a multi-level throttle is analogous to allowing a driver to decide on how quickly to apply the brake based on a variety of factors. For example, for this embodiment, the temperature set-points and logic partitions of the integrated device affect application of the throttle when trying to reduce power consumption, although the claimed subject matter is not limited in scope in this respect.

In this embodiment, the integrated device is partitioned into a plurality of logic blocks to support a multi-level throttle. In alternative embodiments, a multi-level throttle may coexist with a full chip throttle of an integrated device.

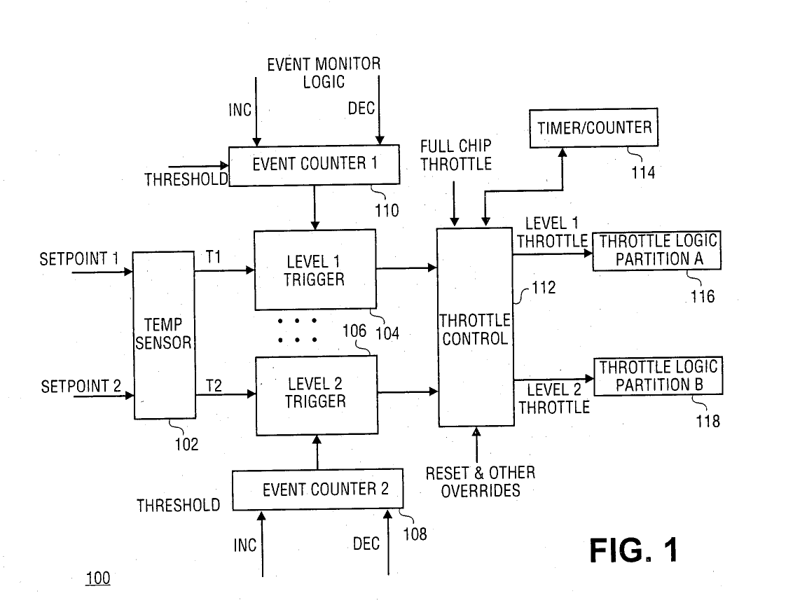

FIG. 1 is a schematic diagram illustrating an embodiment of a throttle logic apparatus in accordance with the claimed subject matter. Embodiment 100 comprises, but is not limited to, a temperature sensor 102, a plurality of trigger blocks, such as, 104 and 106, a plurality of event counters, such as, 108 and 110, a throttle control 112, a timer/counter 114, and a plurality of logic partitions 116 and 118. In one aspect, this embodiment may facilitate a multi-level throttle by selectively throttling one or more of the logic partitions based at least in part on a temperature sensor, event counters, and first and second level triggers. The multi-level throttle, temperature sensor, event counters, and first and second level triggers are discussed in further detail, hereinafter.

Temperature sensor 102 may support a plurality of temperature set points. For example, the temperature sensor generates a signal for each temperature set point. In one embodiment, the temperature sensor may activate a T1 signal if the die temperature of the integrated device meets or exceeds a first temperature set point (T1). Likewise, the temperature sensor may activate a T2 signal if the die temperature of the integrated device meets or exceeds a second temperature set point (T2), where T2, is greater than T1. Subsequently, as shown in FIG. 1, the temperature sensor forwards the T1 and T2 signals to a plurality of trigger blocks 104 and 106, respectively. However, the claimed subject matter is not limited to two temperature set points. For example, the temperature sensor may support more than two set points or additional temperature sensors may be utilized to support additional logic partitions.

In this embodiment, trigger block 104 receives the T1 signal and trigger block 106 receives the T2 signal. Event counters 108 and 110 are coupled to trigger block 106 and 104, respectively, and receive INC and DEC signals from an event monitor logic. Likewise, the event counters receive a predetermined threshold value. In one embodiment, the predetermined threshold value may be a detection of a predetermined instruction, or a priority request, or a counter value.

In this embodiment, the first level trigger may be enabled when the sensed die temperature meets or exceeds the first temperature set point T1 and event counter 110 meets or exceeds the predetermined threshold value. Likewise, the T2 trigger may be enabled when the sensed die temperature meets or exceeds the second temperature set point T2 and event counter 108 has exceeded its predetermined threshold value, where T2 is greater than T1. In one embodiment, the threshold value is identical for both event counters. Alternatively, in another embodiment, different threshold values may be used. Likewise, more than two event counters may be employed in alternative embodiments.

In one embodiment, throttle control 112 may receive an output signal of the trigger blocks to control the execution of the different triggers. For example, if the first level trigger is active, a timer/counter 114 may decrement from a preset value while the throttle control 112 throttles a logic block 116 until the value of the timer/counter is zero. However, throttle control 112 may also disable the first level trigger when the integrated device's die temperature is less than T1. In contrast, if the integrated device's die temperature meets or exceeds the second temperature set point T2 while the first level trigger is active, the second level trigger may be enabled if event counter 108 meets or exceeds the threshold value. Subsequently, the first level trigger may be disabled as a result of enabling the second level trigger.

The first level trigger may be disabled when the integrated device's die temperature falls below the first temperature set point T1 and the timer/counter value is zero. Likewise, the second level trigger may be disabled when the integrated device's sensed die temperature falls below the second temperature set point T2 and the timer/counter value is zero. However, if the integrated device's temperature meets or exceeds a third temperature set point, T3, where T3 is greater than T2, results in disabling the first and second level triggers and enabling a full chip throttle.

As previously described, a logic partition is throttled upon enabling either the first level or second level trigger. For example, the throttle of a logic partition may result in intermittently halting execution of the combinational logic, state machines, registers, etc. within the logic partition. In one embodiment, the integrated device may comprise a plurality of logic partitions forming a functional operation. In another embodiment, the logic partitions may span across the functional unit block levels (FUBs). FUBs are well known in the art for referring to one or more circuit schematics to perform a function, such as, an adder function. Of course, the claimed subject matter is not limited in scope to any particular arrangement of logic partitions to be throttled.

In one embodiment, for example, the integrated device may be partitioned as logic block 116, comprising all the FUBs and logic employed to issue instructions and logic block 118, comprising all the FUBs and logic employed to execute instructions speculatively. Likewise, the claimed subject matter supports multi-level throttling for more than two logic partitions. For example, another temperature sensor may be utilized for additional logic partitions. Therefore, alternative embodiments may include more than two logic partitions or entirely different partitions, such as, an input/output (I/O) partition, a floating-point unit (FPU) partition, etc.

In another embodiment, the throttle control may override and terminate the first level and/or second level triggers for a variety of break and control conditions. For example, a reset or full chip throttle may result in disabling the first level and second level triggers. Alternatively, control information for an internal or external feature that is implemented in fuses or in a register, such as, a mode shift register (MSR) may result in termination of the first level and second level triggers.

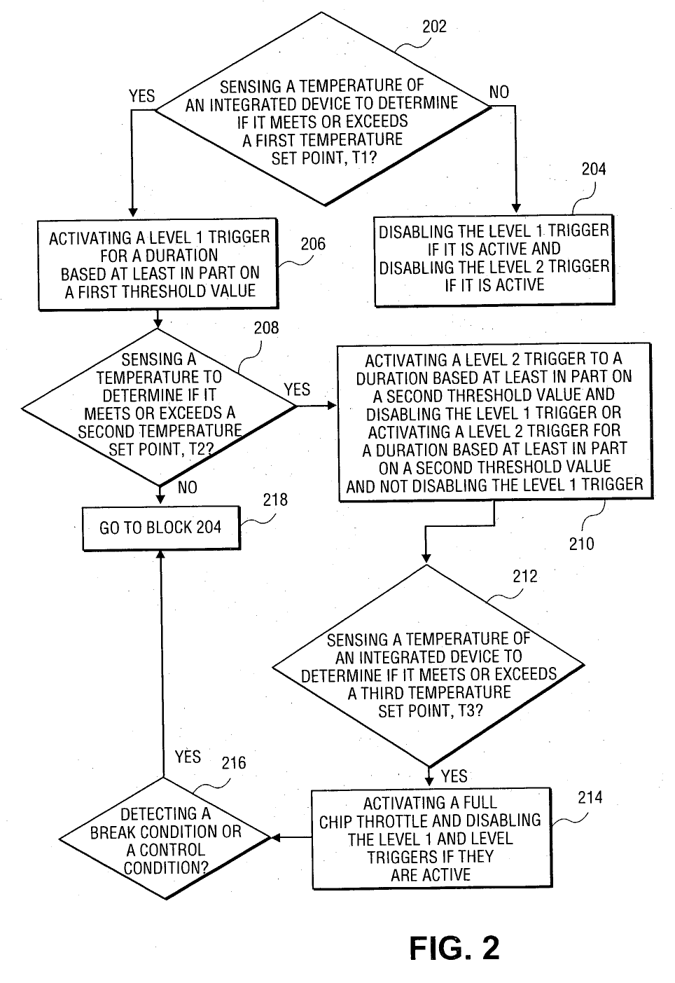

FIG. 2 is a flowchart illustrating an embodiment of a method in accordance with the claimed subject matter. This particular flowchart comprises a plurality of diamonds and blocks 202, 204, 206, 208, 210, 212, 214, 216, and 218, although, of course, the claimed subject matter is not limited to the embodiment shown. For this embodiment, the flowchart depicts, a multi-level throttle integrated with a full chip throttle of an integrated device. For example, in this embodiment, the multi-level throttle is controlled by two triggers, a first level and second level trigger. The two triggers are based at least in part on a first temperature set point T1 and a second temperature set point T2, respectively; of course, the claimed subject matter is not limited to two triggers. This particular embodiment enables multi-level triggers based at least in part on a plurality of temperature set points, threshold values, break, and control conditions, although, again the claimed subject matter is not limited to this particular embodiment.

In this embodiment, a temperature sensor senses a die temperature of an integrated device to determine if it meets or exceeds a first temperature set point T1, as illustrated by diamond 204. The die temperature may be sensed by a single thermal sensor diode or averaging a plurality of die temperatures from a plurality of thermal sensor diodes coupled to the die or a package of the integrated device. If so, a first level trigger is enabled for a duration based at least in part on a first threshold value, as illustrated by block 206. Otherwise, the first level trigger and the second level trigger are disabled, as illustrated by block 204. In one embodiment, the threshold value is a timer count value.

In this embodiment, a temperature sensor senses a die temperature of an integrated device to determine if it meets or exceeds a second temperature set point T2, where T2 is greater than T1, as illustrated by diamond 208. If so, a second level trigger is enabled for a duration based at least in part on a second threshold value and the first level trigger is disabled, as illustrated by block 210. Alternatively, a second level trigger may be enabled for a duration based at least in part on a second threshold value and the first level trigger is not disabled, as illustrated by block 210. Otherwise, the flowchart proceeds to block 204, via by block 218, when the die temperature is less than the second temperature set point T2.

In this embodiment, a temperature sensor senses a die temperature of an integrated device to determine if it meets or exceeds a third temperature set point T3, where T3 is greater than T2, as illustrated by diamond 212. If so, in one embodiment, a full chip throttle is enabled and the first level and second level triggers are disabled, as illustrated by block 214. Likewise, the first level and second level triggers are disabled upon detection of a break or control condition, as illustrated by diamond 216 and block 204.

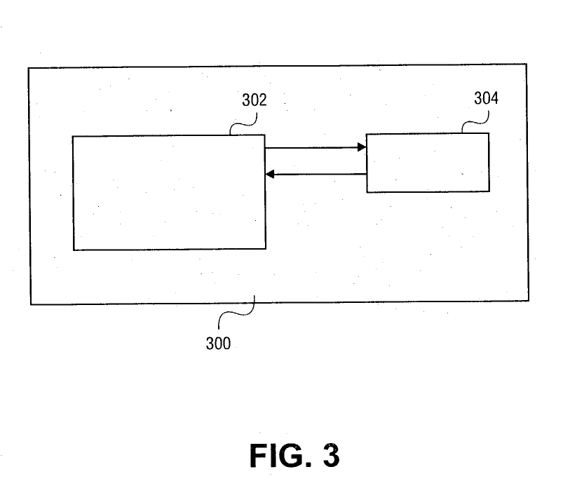

FIG. 3 is a block diagram illustrating a system that may employ the embodiment of either FIG. 1 or FIG. 2, or both. In one embodiment, system 300 comprises a computer or a computing system, such as, a personal digital assistant, Internet table, or a communication device. The system may comprise, but is not limited to, a processor 302 and a memory 304. The processor may execute instructions and request data from the memory. The system may comprise at least one temperature sensor. In one embodiment, the temperature sensor is integrated within the processor. In another embodiment, the temperature sensor is coupled to a package of the processor. In one embodiment, the system may incorporate the multi-level throttle, such as, for example, the embodiments previously described.

Although the claimed subject matter has been described with reference to specific embodiments, this description is not meant to be construed in a limiting sense. Various modifications of the disclosed embodiment, as well as alternative embodiments of the claimed subject matter, will become apparent to persons skilled in the art upon reference to the description of the claimed subject matter. It is contemplated, therefore, that such modifications can be made without departing from the spirit or scope of the claimed subject matter as defined in the appended claims.

1. A method for an integrated device with at least a first and second partition comprising:
comparing a die temperature of the integrated device to a first temperature set point, and enabling a first level trigger for the first partition of the integrated device based on the comparison; and
comparing the die temperature of the integrated device to a second temperature set point, and enabling a second level trigger for the second partition of the integrated device based on the comparison, wherein the second temperature set point is greater than first temperature set point.

2. The method of claim 1 further comprising:
comparing the die temperature to the first temperature set point is to determine whether the die temperature meets or exceeds the first temperature set point;
comparing the die temperature to the second temperature set point is to determine whether the die temperature meets or exceeds the second temperature set point; and
determining whether the die temperature of the integrated device meets or exceeds a third temperature set point, wherein the third temperature set point is greater than the second temperature set point, if so,
enabling a full chip throttle for the integrated device; and
disabling the first and second level triggers if they are active.

3. The method of claim 1 further comprising terminating the first and second level triggers in response to a break or control condition.

4. The method of claim 1 wherein enabling the first level trigger is based at least in part on meeting or exceeding a first threshold value stored in a first event counter.

5. The method of claim 1 wherein enabling the second level trigger is based at least in part on meeting or exceeding a second threshold value stored in a second event counter.

6. The method of claim 1 wherein enabling the first level trigger is for a duration based at least in part on a counter value.

7. The method of claim 1 wherein enabling the second level trigger is for a duration based at least in part on a counter value.

8. The method of claim 1 wherein the first and second partition are comprised within the same functional block of the integrated device.

9. The method of claim 3 wherein the break condition comprises a reset condition.

10. The method of claim 3 wherein the control condition comprises an internal or external feature that is implemented in fuses or in a register.

11. A method for reducing power consumption of an integrated device, said device including at least a first and second partition, comprising:
throttling the first partition based at least in part on a first level trigger; and
throttling both the second partition and disabling the first level trigger based at least in part on a second level trigger.

12. The method of claim 11 wherein throttling the first level trigger is based at least in part on meeting or exceeding a first threshold value stored in a first event counter.

13. The method of claim 11 wherein throttling the second level trigger is based at least in part on meeting or exceeding a second threshold value stored in a second event counter.

14. The method of claim 11 wherein throttling the first level trigger is for a duration based at least in part on a counter value.

15. The method of claim 11 wherein throttling the second level trigger is for a duration based at least in part on a counter value.

16. The method of claim 11 further comprising arranging the first and second partition based at least in part on a functionality of the integrated device.

17. The method of claim 11 wherein throttling the first partition comprises meeting or exceeding a first temperature set point for a die temperature of the integrated device

18. The method of claim 11 wherein throttling the second partition comprises meeting or exceeding a second temperature set point for a die temperature of the integrated device, wherein the second temperature set point is greater than first temperature set point.

19. The method of claim 11 further comprising terminating the first and second level triggers in response to a break condition.

20. The method of claim 11 further comprising terminating the first and second level triggers in response to a control condition.

21. The method of claim 19 wherein the break condition comprises a reset condition.

22. The method of claim 19 wherein the control condition comprises an internal or external feature that is implemented in fuses or in a register.

23. A processor comprising:
at least a first and second logic partition;
a temperature sensor, coupled to the processor, to detect a die temperature of the processor; and
throttle logic to control a multi-level throttle of the processor to throttle the first logic partition based at least in part on a first level trigger and to throttle the second logic partition based at least in part on a second level trigger.

24. The processor of claim 23 wherein the first level trigger is capable of being enabled if the die temperature meets or exceeds a first temperature set point.

25. The processor of claim 23 wherein the second level trigger is capable of being enabled if the die temperature meets or exceeds a second temperature set point, wherein the second temperature set point is greater than first temperature set point.

26. The processor of claim 23 wherein the multi-level throttle is capable of being disabled if a full chip throttle is enabled, the full chip throttle is enabled when the die temperature meets or exceeds a third temperature set point, wherein the third temperature set point is greater than the second temperature set point.

27. A system comprising:
a processor with at least a first and second logic partition;
a memory, coupled to the processor;
a temperature sensor, coupled to the processor, to detect a die temperature of the processor; and
a throttle logic to integrate a multi-level throttle with a full chip throttle of the processor.

28. The system of claim 27 wherein the multi-level throttle is based at least in part on a first level trigger to throttle the first logic partition and a second level trigger to throttle the second logic partition

29. The system of claim 27 wherein the system comprises at least one of a computer, internet tablet, communication device, and a personal digital assistant.

30. The processor of claim 28 wherein the first level trigger is capable of being enabled if the die temperature meets or exceeds a first temperature set point.

31. The processor of claim 30 wherein the second level trigger is capable of being enabled if the die temperature meets or exceeds a second temperature set point, wherein the second temperature set point is greater than first temperature set point.

32. The processor of claim 31 wherein the full chip throttle is capable of being enabled if the die temperature meets or exceeds a third temperature set point, wherein the third temperature set point is greater than the second temperature set point.
